(19) United States
(12) Patent Application Publication
(10) Pub. No.: US 2004/0027280 A1
(43) Pub. Date: Feb. 12, 2004

(54) Method for calibrating integrated location finding systems

(76) Inventors: Joseph Nir, Rehovot (IL); Baruch Shayevits, Rishon Lezion (IL); Hanoch Cohen, Rishon Lezion (IL); Eran Dochovni, Moshav Nir Zvl (IL); Shimuel Kirali, Kiryat Ono (IL)

Correspondence Address: Mark M Friedman, Bill Polkinghorn, Discovery Dispatch, 9003 Florin Way, Upper Marlboro, MD, 20772, US

(21) Appl. No.: 10/381,692

(22) PCT Filed: Jun. 20, 2001
(86) PCT No.: PCT/US01/19733

(51) Int. Cl. G01S 1/24; G01S 3/02

(52) U.S. Cl. 342/387; 342/464

(57) ABSTRACT

A method for calibrating a receiver employing integrated location procedures, wherein signals from two radio net-work sources are employed. A system delay (46) is calculated for a first network, and another system delay (46) is calculated for a second network. The differential system delay (50) is stored (53) and used in future location determination sessions. The differential system delay is updated repeatedly, if reception conditions permit.

### FIELD OF THE INVENTION

The present invention is in the field of navigation systems that use ranging to radio sources as their measurement technology. More specifically it relates to such systems that determine the location of a receiver of navigation satellites and terrestrial radio sources using signals from both source types.

### BACKGROUND OF THE INVENTION

Navigation satellites have become a widespread source of navigation information, used by the public in order to determine three dimensional location. The navigation fixes resulting from the use of the GPS satellite system are precise enough for many applications. The free and easy access available to the navigation signals of this satellite system practically around the globe make the GPS a very popular location tool. The navigation signals of the satellites are used by measuring their travel time from the transmitter to the receiver as will be explained next. Theoretically, the length of time elapsing between the transmission time Tₜ and the reception time Tᵣ is proportional to the range (distance) between the transmitter and the receiver. The speed of light c, when multiplied by the time elapsing between the transmission and the reception equals to the range. This is described by the following equation:

Equation 1:

(Tᵣ−Tₜ)xc=R (range between the receiver and the transmitter).

To put this theoretical consideration into practice, however, it is a required to overcome the obstacle caused by the imperfect synchrony existing between the clock on board the satellite and the clock of the receiver. This synchrony mismatch potentially degrades the accuracy of the navigation, and as a result of which an unknown factor CB (clock bias) is added to the above equation, changing the unknown R into PR (pseudorange):

Equation 2:

(Tᵣ−Tₜ)xC−(CB)xc=PR (pseudorange).

If the time of transmission is known, and the time of reception at the receiver is known, as well as the place of the satellite with respect to the earth at the time of transmission is known, then the PR to the satellite can be calculated. Measurements from three satellites would have been required for calculating the 3-dimensional position of a satellite with respect to the earth were it not for a clock bias. If however an extra measurement to an additional satellite is made, the clock bias could be eliminated from the equations, facilitating thus the determination of a 3-dimensional position of the receiver in earth geographical terms. An underlying condition for the foregoing procedure is that the clock bias for the four measurements made is the same. To ensure this, the measurements should be performed concomitantly.

Limitations to accessing the GPS signals exist however, which may cause a reduction in accuracy of the location found by the GPS satellite based system. Such limitations acre typically caused by environmental conditions. For example urban environment may cause reflected signal- to be received better than a direct signal Attenuation to direct or reflected signals may be caused by buildings or trees. In order to overcome some of the drawbacks associated with the availability of GPS signal and specifically of good quality GPS signal, systems that use cellular network signals as navigation signals were development more recently, such a system is disclosed in WO 9711384. Other, still more complicated navigation systems use navigation signals from more than one type of network. Typically such systems utilize GPS satellite source in addition to BTSs (base transceiver station) of cellular networks, as is disclosed in WO 9961934, the contents of which are incorporated herein by reference.

### SUMMARY OF THE INVENTION

An object of the present invention is to provide a method for calibrating a receiver of navigation signals employing integrated location procedures.

In accordance with the present invention, calibration is performed in a receiver employing an integrated location procedure. For each radio network source a separate system delay value is determined which typifies the offset associated with its signal. The receiver then keeps the difference in delay values associated with each network and uses this stored value in any location determination session. Calibrations are recurringly performed, such as according to a schedule and conditionally upon the availability of sufficient data to find a fix for the receiver without the need to use two radio networks signals for a single fix. Therefor, in accordance with the present invention, location can be obtained from an ancillary source, or it can be determined by regular pseudoranging methods.

### BRIEF DESCRIPTION OF THE DRAWINGS

FIG. 1 is a schematic block diagram description of a typical receiver to which the present invention relates;

FIG. 2 is schematic representation of the delays involved in a receiver system utilizing dual source types;

FIG. 3 is a flow chart describing the steps leading to a calibration of the system in accordance with the present invention;

FIG. 4A is a schematic illustration of the setup of base stations in which the method of the invention takes place, showing in particular the connections of the reference receiver;

FIG. 4B is a schematic illustration of the setup of base stations in which the method of the invention takes place, showing in particular the connections of the MRSL.

### DETAILED DESCRIPTION OF THE PRESENT INVENTION

A mobile receiver seeking location (MRSL) of the invention, receives navigation signals from at least two types of radio network sources, each of which source is typically a network containing a multiplicity of radio sources. One type is a satellite navigation network system, typically the GPS system. A second type of radio network source is typically a cellular communication network. Most conveniently, the mobile receiver of the invention is a cellular mobile phone onto which an add-on satellite receiver has been connected.

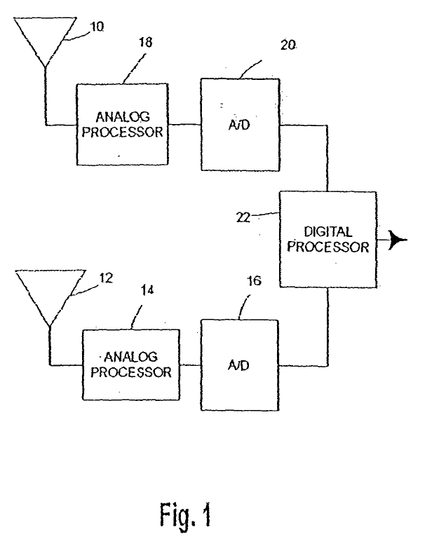

Reference is now made to FIG. 1 which describes schematically the circuitry of a receiver of RF sources involved in the location procedures implemented by the present invention is. Antennae 10 and 12 receive signals of radio sources, and the signals are subsequently processed by analog circuitry. Circuitry 14 processes signals of a certain radio source, later transformed by digitizer 16 into a digital signal, which is subsequently processed by digital processor 22. In parallel, analog circuitry 18 processes signal of a different radio source, digitizer 20 transforms the signals into digital format, which are subsequently processed by digital processor 22.

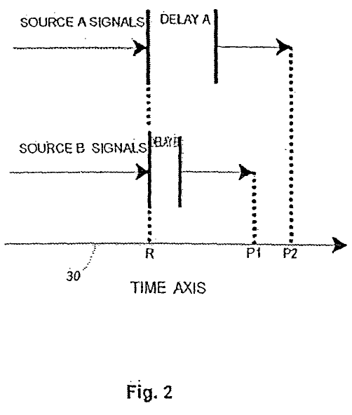

Reference is now made to FIG. 2, which describes schematically the problem underlying the need for the solution as provided by the present invention. Two separately propagated signals, one of network A, and one of network B are respectively issued. These signals are concomitantly received by respective antennae at time R on universal time axis 30. Processing of the signals ensues, typically on partially separated hardware. The respective signals exhibit different analog processing time, which culminates in a phase of analog to digital transformation which subsequently gives rise to digital processing. The onset of digital processing is marked by P1 and P2, both on the time axis 30. The a delay caused by the analog processing and transformation to digital, induces a delay in the incipience of digital processing. Thus, point P1 indicates a certain time on the time axis in which the digital processing of B source signal begins. A point P2 marks a point on the time axis at which digital processing of A source signal begins. Thus, the analog circuitry, chiefly, induces a delay in each of the respective signals of the two different RF sources. This delay is not constant and is subject to the fluctuating influence of environmental conditions, such as temperature, and also to aging of the components. For this reason, calibration should be performed recurringly. The Digitizing hardware, supported by the clock, also induces delay. As can be seen in FIG. 2, these delays are not equal, and the delay induced by the processing on the signal of A type source is larger than the delay induced by the processing on the signal of type B source. Delay is caused not only by components of the receiver, and external effects of objects cause the incoming signal to bounce back and forth until reaching the antenna. This is called “multipath” delay and it can be quantized roughly according to the type of environments surrounding the receiver. For example, moderately urbanized area causes roughly a 100 meters of delay (in path length terms).

According to the present invention, in integrated location systems, system delay is calculated for each type of radio source rather than commonly for all radio sources. To do that, the receiver calculates the system delay with regards to one source type at a time. Accordingly, system delay is defined as delay that the receiver induces to the navigation signal of a specific type of source, in an integrated location system. In analogy to equation 2:

Equation 3

(Tᵣ−Tₜ)xc−(system_{—}delay)xc=PR (pseudorange).

Referring to a specific source type, such as a GPS satellite system. Accordingly, to determine system_delay, a set of at least four measurements from respective sources of the same source type are to be made. If the integrated location system refers to two such source types, two such separate sets are to be performed.

Performing Calibration

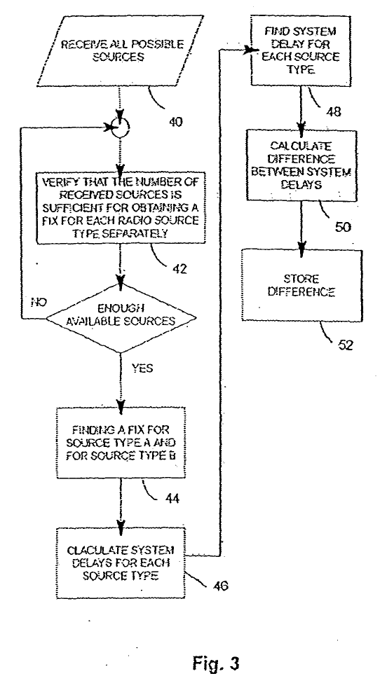

In accordance with the present invention, a navigation fix is obtained by each radio source type, using a single radio type of radio network source at a time. Thus, if the system is planned to operate with two radio source types, two separate navigation fixes are obtained, one for each radio source type. In order to explain the overall process of primary calibration of the present invention, reference is made now to FIG. 3 which describes the sequence of steps carried out in connection with the calibration. In step 40 all possible available sources are received, and in step 42 the number of radio sources of each type are assessed as to their sufficiency to determine a location fix for each radio source type separately. The process does not continue onwards unless enough radio sources are received. In step 44 two separate procedures are carried out for finding two fixes accordingly. Then, in step 46 system delay (S_D) is calculated for each radio source type. If source type A is a GPS satellite system, the procedure typically follows the regular location finding procedure for the GPS system. Referring to equation 2 above, PRs (pseudoranges) to each reference satellite are calculated by correlating receiver to the satellite's navigation code phase (see WO 9961934). Thus, in such a case, a set of four equations are obtained, describing the distance from a receiver of the satellites, to each of the four reference satellite 1, 2, 3, and 4, as follows, in equation set 1:

PR1+S_{—}Dxc=((X₁−X_{M})²+(Y₁−Y_{M})²+(Zᵢ−Z_{M})²)^{1/2}

PR2+S_{—}Dxc=((X₂−X_{M})²+(Y₂−Y_{M})²+(Z_{2-Z}_{M})²)^{1/2}

PR3+S_{—}Dxc=((X₃−X_{M})²+(Y₃−Y_{M})²+(Z₃−Z_{M})²)^{1/2}

PR4+S_{—}Dxc=((X₄−X_{M})²+(Y₄−YM)²+(Z_{4-Z}_{M})²)^{1/2}

In this set of equations, the PRs are known, the satellite's position is obtained from the ephemeris data of the satellite's navigation signal, thus leaving four unknowns: X_{M}, Y_{M}, Z_{M} and S_D.

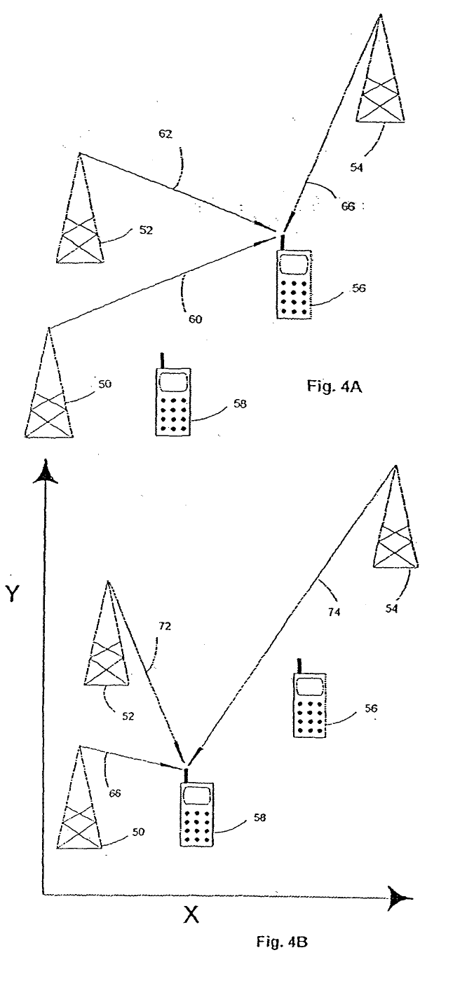

The S_D of the above set of equations will be referred to as S_D_{A} which is accordingly a parameter relating to source type A. The system needs however to be calibrated with respect to a second type of radio network source to which it is tuned. Such a system is described in WO 9961934. The second type of radio network source is in a preferred embodiment of the present invention, a cellular network system, typically an unsynchronized network such as GSM. As disclosed in WO 9921028, the method for determining location of receivers of the cellular system requires several radio sources of the cellular network to be received by the receiver requesting location determination. In a similar method to the method described above, time travel of radio signals are received by the mobile receiver. Reference is now made to FIG. 4A which describes schematically the geometrical relationship between the MRSL and other elements of the cellular network. Base station 1 (BTS1) 50 transmits signals in concentric signal propagation contours, as do BTS2 52 and BTS3 54. A reference receiver 56 and MRSL 58 receive and process those signals. Line 60 represents the distance (range, R) between the base station 50 and the reference receiver 56, line 62 represents the range between base station 52 and the reference receiver, and line 66 represent the range between base station 54 and the reference receiver 56. In FIG. 4B to which reference is now made, base station 50 is at distance 68 from MRSL 58, base station 52 is at distance 72 to the MRSL 58, and base station 54 is at a distance 74 to the MRSL 58.

The range (distance) between the reference receiver 56 and BTS 1 (50), designated by arrow 68 is proportional to the lapse of time from transmission (t_{TR1}) from the base station, to the reception by the reference receiver (t_{RR1}) plus the error caused by the difference in clocks of the transmitter and receiver. This is explained in WO 9961934.

Thus, for the distinguishable signals of the three base stations, received by the reference receiver, the following equations are formulated in equation set 2:

For BS1: (t_{TR1}−t_{RR1})xc=PR1+clock_{—}biasxc=R1

For BS2: (t_{TR2}−t_{RR2})xc=PR2+clock_{—}biasxc=R2

For BS3: (t_{TR3}−t_{RR3})xc=PR3+clock_{—}biasxc=R3

In this set of equations, t_{RR1} is known, t_{RR2} is known, and t_{RR3} is known. Also known are the ranges between the respective base stations and the reference receiver, R1, R2, and R3. For a two dimensional setup of base stations and receivers (with no elevation difference), three equations involving three base stations suffice, as explained in WO 9961934

If each distinguishable signal received by the reference receiver is also received by the MRSL, the following equation set is formulated:

Equation set 3:

((XB1−XM)²−(YB1−YM)²)^{1/2}=(t_{TR1}−t_{RR1})xc+S_{—}Dxc

((XB2−XM)²−(YB2−YM)²)^{1/2}=(t_{TR2}−t_{RR2})xc+S_{—}Dxc

((XB3−XM(YB3−YM)²)^{1/2}=(t_{TR3}−t_{RR3})xc+S_{—}Dxc

Wherein M represents MRSL

in this equation set, XM is unknown, YM is unknown and T_{TR1}, t_{TR2}, and t_{TR3} are unknown. However, t_{TR1}, t_{Tr2}, and t_{TR3} can be calculated each from the respective equations of equation set 2 above. Also S_D can be calculated. It will thenceforth be referred to as S_DB.

Once the two S_Ds (system delays) are calculated, a differential system delay (S_D_{d}) is calculated as follows:

Equation 4:

|S_{—}D_{A}−S_{—}D_{B}|=S_{—}Dd

S_D_{d} is stored in the memory of the MRSL or elsewhere in the system for future use in location determination sessions.

If the location of the MRSL is obtained by way of ancillary data, less sources of each radio network source are to be received and processed. Accordingly, only the minimal number of sources required for calculating the S_D sould be processed.

Determining Location by a Calibrated Receiver

Once S_D_{d} is stored in the memory of the receiver, it can be used in each location determination sessions. As pointed out earlier, the system must be repeatedly calibrated, and as a result of each calibration, the value of S_D_{d} is corrected. Therefore, each location determinations session employs the last version of S_D_{d}. To demonstrate how the correction is made in practice, an example in which the MRSL is visualized in a two dimensional world (i.e., in a flat surface). In such a case, at least three independent sources are required to provide the MRSL's location. In this example, signals from two base stations and one satellite are incorporated into a set of three equations.

$$\begin{matrix}Equation set 4 : \\ For BS 1 : ( {t}_{TR 1} - {t}_{RR 1} ) xc = PR 1 + {S\_D}_{C} xc = R 1 \\ For BS 2 : ( {t}_{TR 2} - {t}_{RR 2} ) xc = PR 2 + {S\_D}_{C} xc = R 2 \\ For sat 1 : PR 4 + {S\_D}_{s} xc = R 4\end{matrix}$$

Wherein S_D_{c} is a system delay relating to the cellular network, and S_Dₛ is a system delay relating to the satellite network.

To solve the equations, first by substitution:

$$\begin{matrix}Equation set 5 : \\ For the cellular network PR 1 + {S\_D}_{C} xc = {( {( {X}_{B 1} - {X}_{M} )}^{2} - {( {Y}_{B1} - {Y}_{M} )}^{2} )}^{1 / 2} \\ PR 2 + {S\_D}_{C} xc = {( {( {X}_{B 2} - {X}_{M} )}^{2} - {( {Y}_{B2} - {Y}_{M} )}^{2} )}^{1 / 2} \\ For the satellite : PR 3 + {S\_D}_{s} xc = {( {( {X}_{s 1} - {X}_{M} )}^{2} - {( {Y}_{s1} - {Y}_{M} )}^{2} )}^{1 / 2} \end{matrix}$$

The PRs are obtained by direct measurement, the position of the satellite is obtained from the satellite navigation signal, and the base station coordinate are obtained from the cellular network.

Therefore, the unknowns are as follows: X_{M}, Y_{M}, S_D_{c}, and S_Dₛ The fourth equation is furnished from the basic provision of the invention as embodied in equation 5:

Equation 5:

S_{—}D_{c}−S_{—}Dₛ|=S_{—}D_{d} (wherein S_{—}D_{d} is stored in the memory).

Now there are four equations and four unknowns

1. A method for calibrating a receiver employing integrated location procedures, wherein said receiver receives radio signals transmitted from sources of two distinct radio networks, said calibration comprising:
determining a location of said receiver,
determining a system delay of said receiver utilizing signals transmitted from at least one source of a first radio network,
determining a system delay of said receiver utilizing signals transmitted from at least one source of a second radio network,
calculating a difference between said delay values,
storing said difference between said delay values, and
using said difference in a location determination session.

2. A method for calibrating a receiver as in claim 1 and wherein a location of said receiver is determined by using signals transmitted from sources of said first radio network.

3. A method for calibrating a receiver as in claim 1 and wherein a location of said receiver is determined by using signals transmitted from sources of said second network.

4. A method for calibrating a receiver as in claim 1 and wherein a location of said receiver is determined by ancillary data.

5. A method for calibrating a receiver as in claim 1 and wherein said first network is a navigation satellites network.

6. A method for calibrating a receiver as in claim 1 and wherein said second network is a cellular telephony network.

7. A method for calibrating a receiver as in claim 6 and wherein said cellular telephony network is a GSM network.

8. A method for determining a location of a receiver of two radio networks, wherein said receiver performs an integrated location procedure, comprising:
receiving signals from said two radio networks,
calculating pseudoranges to radio sources of two radio networks, and
calculating, based on said pseudoranges and on a stored differential system delay, ranges to said radio sources.
